(19) United States
(12) Patent Application Publication
(10) Pub. No.: US 2010/0161107 A1
(43) Pub. Date: Jun. 24, 2010

(54) MACHINE CONTROL FOR A NUMERICALLY CONTROLLED MACHINE TOOL

(75) Inventors: Gregor KAPPMEYER, Bad Homburg (DE); Wolfgang PIECZEIT, Dornburg (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: ROLLS-ROYCE DEUTSCHLAND LTD & CO KG, Blankenfelde-Mahlow (DE)

(21) Appl. No.: 12/635,112

(22) Filed: Dec. 10, 2009

(30) Foreign Application Priority Data
Dec. 22, 2008 (DE) 10 2008 064 172.3

(51) Int. Cl. G05B 19/404

(52) U.S. Cl. 700/173

(57) ABSTRACT

On a numerically controlled machine tool a sub-program is integrated into the given program for controlling the machine tool by which a periodic change of at least one cutting tool parameter is effected in one processing cycle, or also in several processing cycles, or in certain length and diameter zones of the workpiece characterized by tool vibrations and leading to inferior workpiece quality. By way of the periodic cutting parameter change, self-excited tool vibrations are avoided in these sensitive machining areas, thereby enabling tool wear to be reduced and workpiece quality improved. Furthermore, this intervention into the machining program is documentable and identically reproducible for each workpiece—independently of the expertise and personal judgement of the operator.

This application claims priority to German Patent Application DE 10 2008 064 172.3 filed Dec. 22, 2008, the entirety of which is incorporated by reference herein.

This invention relates to a machine control for a cutting machine tool controlled to a given program.

During rough machining and also during finish machining of workpieces by use of program-controlled machine tools, tool vibrations may occur which are likely to affect the machining accuracy and the quality of the workpiece in critical workpiece areas and machining cycles and reduce the life of the tool. Critical workpiece areas are essentially those areas in which the tool engagement conditions and the machining forces between workpiece and tool resulting therefrom, in connection with the dynamic stiffness of the workpiece area machined, can produce tool or workpiece vibrations. An experienced operator will however be able to detect such vibrations and—at least during rough machining—intervene on the basis of his expertise into to the program and consequently into the cutting process, i.e. manually change, as applicable, the cutting movement or cutting speed (rotational speed) and/or the feed movement or feed rate of the tool along the workpiece to minimize the vibrations, for example by operating a speed or feed potentiometer. However, this requires that a—very experienced—operator is permanently present at the machine tool.

Consequently, the same operator will be unable to operate other machine tools at the same time. Furthermore, manual intervention is disadvantageous in that the resultant change of the cutting parameters is not documentable and not exactly reproducible for identical workpieces subsequently to be machined. Also known for avoiding tool vibrations during cutting machining are automated systems using vibration and structure-borne noise sensors. However, the application of such—sensor-based—complex control systems incurs high investment for parameter determination and calibration.

In a broad aspect, the present invention therefore provides for the development, with little investment, of the machine control for a machine tool operating to a given program such that tool vibrations are avoided independently of the operator and increased tool life and constant, high workpiece quality are attained.

In other words, the inventive concept includes integrating at least one sub-program into the given program for controlling the machine tool and effecting a periodic change of at least one cutting tool parameter in one processing cycle, or also in several processing cycles, in certain length or diameter zones of the workpiece characterized by tool vibrations and leading to inferior workpiece quality. By way of the periodic cutting parameter change in these sensitive machining areas, self-excited tool vibrations are avoided, thereby enabling tool wear to be reduced and workpiece quality improved. Furthermore, this program-controlled intervention into the machining program is documentable and identically reproducible for each workpiece—independently of the expertise and personal judgement of the operator. Since no manual intervention into the machining program is required, a reduction of operator staff is possible.

The cutting tool parameters relate preferably to cutting speed, cutting depth and/or feed rate of the tool and are freely selectable, with the periodic change of the feed having no impact on the geometry of the component, but with the periodic change of the cutting depth reducing the wear of the tool cutting edge and also influencing the component geometry.

In a further development of the present invention, the respective cutting parameter is increased or decreased in each of the successive periods in equal or different time spans. The amount of parameter change in successive periods can be equal or differ from period to period.

According to another feature of the present invention, the pattern of the periodic parameter change is undulated or linearly increasing and decreasing.

The present invention is more fully described in light of the accompanying drawings showing a preferred embodiment. In the drawings,

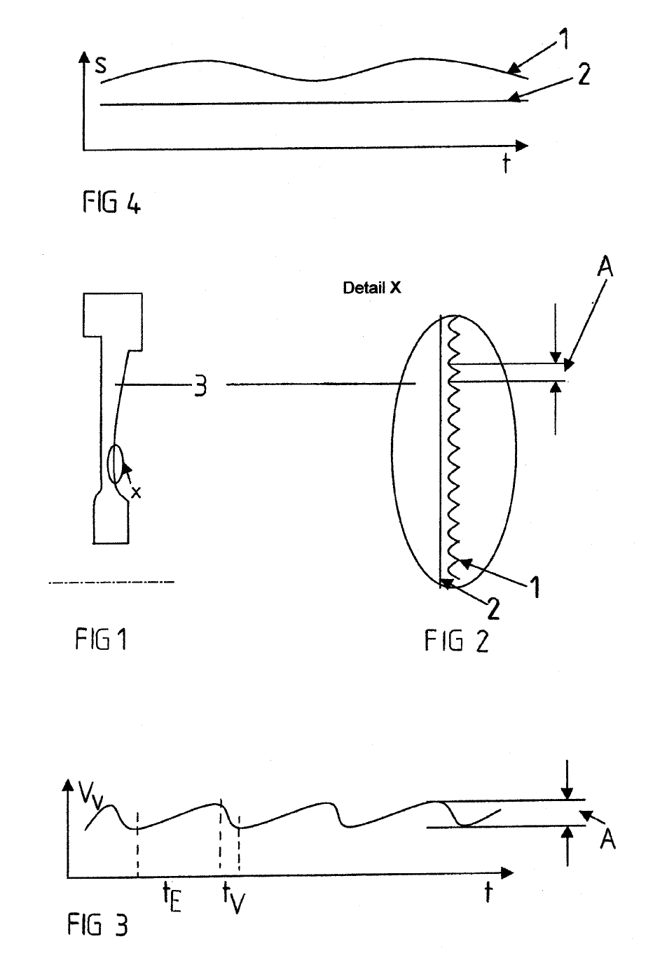

FIG. 1 is a partial view of a rotor disk for a gas-turbine engine, with the disk being machined on a numerically controlled machine tool,

FIG. 2 shows a detail “X” as per FIG. 1, illustrating in enlarged schematic representation a defined sensitive machining area of the rotor disk during a first and a second machining step,

FIG. 3 is a graphical representation of the periodic change of the feed parameters during the machining time,

FIG. 4 is a graphical representation of the periodic change of the cutting depth and of the constant cutting depth during a first or a second machining step, and

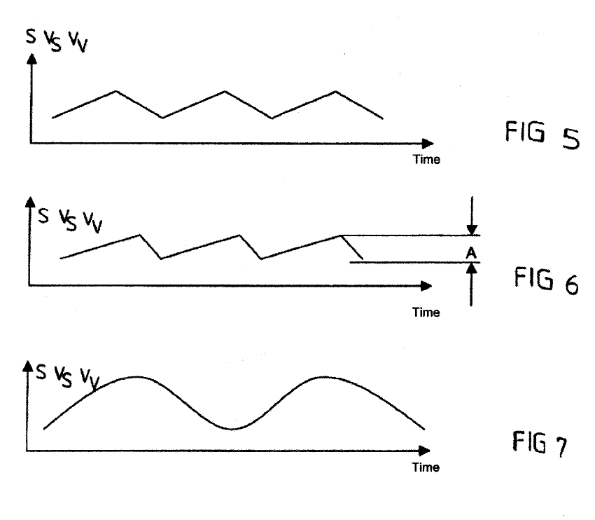

FIGS. 5 to 7 show different patterns of periodic change of the cutting parameters (cutting speed, cutting depth, feed rate) during cutting machining of a workpiece.

FIGS. 1 and 2 show a partial view of a workpiece 3 to be machined, here the rotor disk of an aircraft gas turbine, in a first machining cut 1 in which, as illustrated by FIG. 4, the cutting depth “s” is periodically, here sinusoidally, increased and decreased and in a second machining cut 2 in which the cutting depth “s” remains constant. Likewise, the feed rate “vv”(mm/min) of the tool can, in accordance with the pattern shown in FIG. 3, be periodically changed in the first machining cut 1 and remain constant in the second cut 2, respectively. While the cutting depth “s” in the first machining cut 1 is increased and decreased in the same time span, “tE=tV”, the feed rate is increased in a significantly longer time span than it is decreased, “tE>>tV”. The periodic parameter change described hereinbefore is accomplished without intervention of the operator via control codes of a sub-program integrated into the NC program.

Of course, the present invention is not limited to the exemplary embodiment shown in FIGS. 1 to 3. See FIGS. 4-7. Besides the cutting depth “s” and the feed rate “vv”, it is also possible to periodically change the rotational speed (rpm) or the cutting speed “vs”, respectively, to avoid tool vibration and improve workpiece quality. The respective cutting parameters can be changed individually or in combination of two or several parameters. The time span “tE, tV” in which the increase or decrease of the respective parameter takes place or the amount of change, i.e. the amplitude “A” of the periodic change, is also variable. In addition, the pattern of change can be different, for example sinusoidal or linearly increasing or decreasing. Finally, the amount of parameter change “A” can differ from period to period or alternate periodically. The type and amount of parameter change or the interaction of various parameters depends on the workpiece-specific conditions (material, size, shape, strength properties). While a variation of the feed does not affect workpiece geometry, a periodic change of the cutting depth changes the workpiece geometry while simultaneously reducing critical wear characteristics on the tool.

### LIST OF REFERENCE NUMERALS

1 First machining cut

2 Second machining cut

3 Workpiece

S Cutting depth

tE Time span of parameter increase

tV Time span of parameter decrease

vV Feed rate

vs Cutting speed

A Amplitude/amount of parameter change

What is claimed is:

1. A machine control for a cutting machine tool controlled to a given program, comprising: at least one sub-program with control codes for effecting a periodic change of at least one cutting parameter for avoiding tool vibrations and improving workpiece quality, the sub-program being integrated into the program and being effective in at least one given sensitive machining cycle.

2. The machine control of claim 1, wherein the cutting parameters relate to at least one of a cutting speed “vs”, a cutting depth “s” and a feed rate “vv” of the tool.

3. The machine control of claim 1, wherein an increase of the at least one cutting parameter in each of the successive periods is effected in equal time spans (tE, tV).

4. The machine control of claim 1, wherein a decrease of the at least one cutting parameter in each of the successive periods is effected in equal time spans (tE, tV).

5. The machine control of claim 1, wherein an increase of the at least one cutting parameter in each of the successive periods is effected in different time spans (tE, tV).

6. The machine control of claim 1, wherein a decrease of the at least one cutting parameter in each of the successive periods is effected in different time spans (tE, tV).

7. The machine control of claim 1, wherein an amount of parameter change in successive periods is equal from period to period.

8. The machine control of claim 1, wherein an amount of parameter change in successive periods differs from period to period.

9. The machine control of claim 1, wherein a pattern of the periodic parameter change is undulating.

10. The machine control of claim 1, wherein a pattern of the periodic parameter change is linearly increasing and decreasing.
